(19) United States
(12) Patent Application Publication
(10) Pub. No.: US 2026/0249833 A1
(43) Pub. Date: Aug. 27, 2026

(54) METHOD AND DEVICE FOR CONTROLLING VEHICLE

(71) Applicant: NISSAN MOTOR CO., LTD., Yokohama-shi, Kanagawa (JP)

(72) Inventor: Kazuma SUZUKI, Kanagawa (JP)

(73) Assignee: NISSAN MOTOR CO., LTD., Yokohama-shi, Kanagawa (JP)

(21) Appl. No.: 18/994,203

(22) PCT Filed: Jul. 15, 2022
(86) PCT No.: PCT/JP2022/027800

§ 371 Date: Jan. 14, 2025

(51) Int. Cl. B60W 20/13; B60W 10/02; B60W 10/06; B60W 10/26; B60W 10/30; B60W 20/40; B60W 50/14; B60W 60/00; F02B 63/04; F02D 41/04; F02D 41/06

(52) U.S. Cl. CPC B60W 20/13; B60W 10/06; B60W 10/26; B60W 10/30; B60W 20/40; B60W 50/14; B60W 60/0053; F02B 63/042; F02D 41/042; F02D 41/065; B60W 10/02; B60W 2510/244; B60W 2710/021; B60W 2710/06; B60W 2710/244; B60W 2710/30

(57) ABSTRACT

A vehicle having an automatic driving function has an alternator (2), a starter motor (5), a load A group (21) including one of two automatic driving electric loads that form a redundant system, a load B group (22) including the other automatic driving electric load, a lead-acid battery (6), and a lithium-ion battery (7) for backup. During normal operation, a circuit interrupting switch (13) and a LiB relay (10) are ON. When restarting an engine after an idling stop control, power is supplied to the starter motor (5) from the lead-acid battery (6) with the circuit interrupting switch (13) being in an OFF state. Preferential charge of the lead-acid battery (6) is performed with the circuit interrupting switch (13) being held OFF for a predetermined time period after the restart, and after that, the circuit interrupting switch (13) is turned ON, and the lithium-ion battery (7) is also charged.

### TECHNICAL FIELD

The present invention relates to control of a vehicle having two power storage devices for surely supplying power to an automatic driving electric load necessary for the automatic driving, which appropriately combines securing of power supply for the automatic driving electric load and an idling stop control.

### BACKGROUND ART

A highly reliable power supply configuration is required of a vehicle having an automatic driving function (including a so-called driving assistance function) that operates steering, braking etc. of the vehicle by a control system, as a power supply for the automatic driving electric load including an electric actuator and its control circuit to realize the operation.

Patent Document 1 discloses a configuration provided with, in addition to a main battery formed of a lead battery which supplies power to an electric load necessary for normal travel, an additional battery formed of a lithium-ion battery which supplies power to the automatic driving electric load such as ADAS actuator. This configuration is divided into a first load circuit including the main battery and general electric loads and a second load circuit including the additional battery and the automatic driving electric load, and a circuit disconnecting mechanism is provided between the first load circuit and the second load circuit. Then, change in voltage of each load circuit is monitored, and interruption (disconnection) and connection of the both load circuits are controlled.

However, this Patent Document 1 fails to disclose the idling stop control, also does not disclose how the circuit disconnecting mechanism is controlled when applying the idling stop control.

Patent Document 2 discloses a configuration provided with a main battery formed of a lithium-ion battery and a sub-battery formed of a lead battery in a vehicle having an idling stop function. Normal power supply including the cranking in a normal temperature range is performed using the main battery, whereas the sub-battery is used for power supply to a starter when an engine temperature at a time of engine start is in a low temperature range or a high temperature range.

However, in this Patent Document 2, securing of power supply for maintaining the automatic driving function is not particularly taken into consideration.

### CITATION LIST

### Patent Document

Patent Document 1: Japanese Unexamined Patent Application Publication No. JP2017-177857

Patent Document 2: Japanese Unexamined Patent Application Publication No. JP2008-167652

### SUMMARY OF THE INVENTION

A method of controlling a vehicle having an engine, a generator driven by the engine and generating power, a first power storage device and a second power storage device each charged by power generated by the generator and each supplying power necessary for automatic driving of the vehicle to an automatic driving electric load, and a disconnecting device provided between the first power storage device and the second power storage device, according to the present invention, comprises: when predetermined conditions are satisfied at a time of vehicle stop, executing an idling stop control for stopping the engine; performing cranking of the engine by power of the first power storage device with the disconnecting device being in an interruption state when ending the idling stop control and restarting the engine; and charging the first power storage device without charging the second power storage device with the disconnecting device being held in the interruption state for a predetermined time period after the restart.

When the predetermined conditions are satisfied at the time of vehicle stop, the idling stop control is executed, and the engine stops. When ending this idling stop control and restarting the engine, since the disconnecting device is in the interruption state, the second power storage device is separated (disconnected) from the first power storage device. Therefore, even though power of the first power storage device is consumed due to the cranking, no power is drawn from the second power storage device to the first power storage device side. After the restart, the first power storage device is preferentially charged with the disconnecting device being held in the interruption state. Since the second power storage device is separated (disconnected), a charge state of the first power storage device is quickly recovered.

Hence, even if the idling stop control and the restart associated with the idling stop are frequently repeated, the charge state of the first power storage device is not excessively decreased, and power supply to the automatic driving electric load can be surely continued.

### RIEF DESCRIPTION OF THE DRAWINGS

FIG. 1 is an explanatory drawing showing a system configuration of a power supply system according to an embodiment.

FIGS. 2A to 2D are explanatory drawings showing basic operations of the power supply system according to the embodiment.

FIGS. 3A to 3F are time charts showing charge, discharge etc. of a lead-acid battery and a lithium-ion battery in an idling stop control.

FIGS. 4A to 4D are explanatory drawings showing operations in the idling stop control.

### EMBODIMENTS FOR CARRYING OUT THE INVENTION

An embodiment of the present invention will be described in detail below with reference to the drawings.

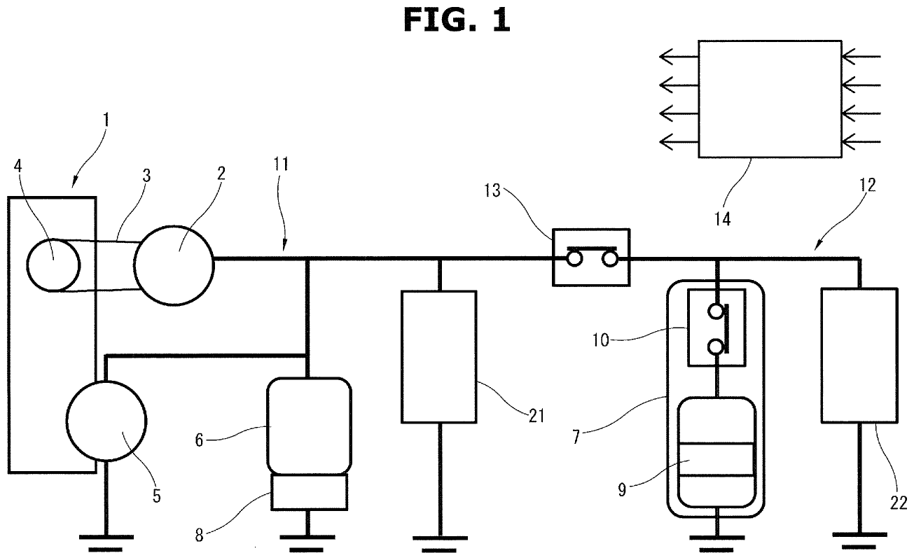

FIG. 1 is an explanatory drawing showing a system configuration of a power supply system in a vehicle having an automatic driving function according to an embodiment. The vehicle of the embodiment is a vehicle that basically travels by power of an engine 1. As the engine 1, for instance, a spark-ignition engine, i.e. a gasoline engine, can be used, but a diesel engine that performs compression self-ignition may be used. The engine 1 has a generator, e.g. an alternator 2. The alternator 2 is driven by a crank pulley 4 of the engine 1 through a belt transmission mechanism 3. The engine 1 further has a starter motor 5 as a starting motor. The starter motor 5 is a general type starter motor having a pinion that engages with and disengages from a ring gear (not shown) of the engine 1.

Although the vehicle has a number of electric loads, in the embodiment, as schematically illustrated in FIG. 1, a number of electric loads are broadly divided into a load A group 21 and a load B group 22. The load A group 21 includes various electric loads necessary for general vehicle travel, for instance, electrical equipment such as fuel system, ignition system and control system of the engine 1, lighting, air conditioner and audio. The load A group 21 further includes a load (corresponding to a first electric load in claims) of one system of automatic driving electric loads necessary for the automatic driving of the vehicle, which are configured as a redundant system.

The load B group 22 includes a load (corresponding to a second electric load in claims) of the other system of the automatic driving electric loads necessary for the automatic driving of the vehicle, which are configured as the redundant system.

These two automatic driving electric loads configured as the redundant system have substantially the same functions. For instance, as an automatic driving function of level 2, a throttle valve of the engine 1 and a brake of the vehicle are controlled by a driving assistance system through electric actuators, and a steering operation of the vehicle is controlled by the driving assistance system through an electric power steering device. In order to be able to maintain the function by the other system when the one system fails, the redundant system is required of the actuators, control circuits etc. which perform the automatic driving.

For instance, the electric power steering device is configured so as to have two motor units and two motor drive control circuit units, each of which forms the redundant system. In this case, one motor unit and the corresponding motor drive control circuit unit correspond to the one automatic driving electric load included in the load A group 21, whereas the other motor unit and the corresponding motor drive control circuit unit correspond to the other automatic driving electric load included in the load B group 22.

The power supply system of the embodiment has two secondary batteries temporarily storing power generated by the alternator 2. That is, the power supply system of the embodiment has a lead-acid battery 6 corresponding to a first power storage device in claims and a lithium-ion battery 7 corresponding to a second power storage device in claims. The lead-acid battery 6 is a so-called 12V battery that is often used as an on-vehicle battery for an automobile. As the lead-acid battery 6, a battery having an appropriate capacity set with consideration given to the whole of the load A group 21 and the load B group 22 is used. The lithium-ion battery 7 is a type of backup power supply mainly used for securing power for the automatic driving electric load of the load B group 22. As the lithium-ion battery 7, for instance, a battery having a capacity that is small relative to a capacity of the lead-acid battery 6 is used. In general, an internal resistance of the lithium-ion battery is small as compared with that of the lead-acid battery, and the lithium-ion battery is superior in charge and discharge characteristics. The lithium-ion battery 7 has a voltage equivalent to that of the lead-acid battery 6 by adjusting the member cells.

The lead-acid battery 6 incorporates a current/voltage sensor 8 that detects a current and a voltage of the lead-acid battery 6. The current and the voltage upon charge and discharge are detected by this current/voltage sensor 8, and a charge amount (SOC) of the lead-acid battery 6 is estimated based on these current and voltage. The lithium-ion battery 7 incorporates a battery management system (BMS) 9 and a LiB relay 10 in a battery pack that accommodates therein the cells. The battery management system 9 detects a voltage and a current per cell unit, and suppresses overcharge and overdischarge of the lithium-ion battery 7, and also performs equalization of the cell voltage, and calculates a charge amount (SOC) of the lithium-ion battery 7. Further, the battery management system 9 detects a cell temperature, and monitors an overcurrent, then has a function of protecting the lithium-ion battery 7 by interrupting (cutting off) the LiB relay 10 at a time of, for instance, an abnormally high temperature or the overcurrent. The LiB relay 10 is formed of a relay having a contact point, and corresponds to a second disconnecting device in claims.

The lead-acid battery 6 is connected to, as a main circuit 11, the alternator 2, the starter motor 5 and the load A group 21. The lithium-ion battery 7 incorporating the LiB relay 10 is connected to, as a backup circuit 12, the load B group 22. The main circuit 11 and the backup circuit 12 are connected to each other through a circuit interrupting switch 13 (corresponding to a disconnecting device in claims). The circuit interrupting switch 13 is configured by a semiconductor switch with consideration given to responsiveness. As illustrated in FIG. 1, the circuit interrupting switch 13 is disposed between the lead-acid battery 6 for supplying power to the starter motor 5 and the load B group 22 formed mainly by the automatic driving electric load.

Disconnection (interruption) of the circuit interrupting switch 13 and disconnection (interruption) of the LiB relay 10 are controlled by a controller 14 that governs a power supply control. The controller 14 further controls a voltage and a power generation amount of the alternator 2, and also controls the starter motor 5 when starting the engine 1 (initial start and restart after the idling stop). It is noted that the controller 14 may be configured by a plurality of modules or controllers.

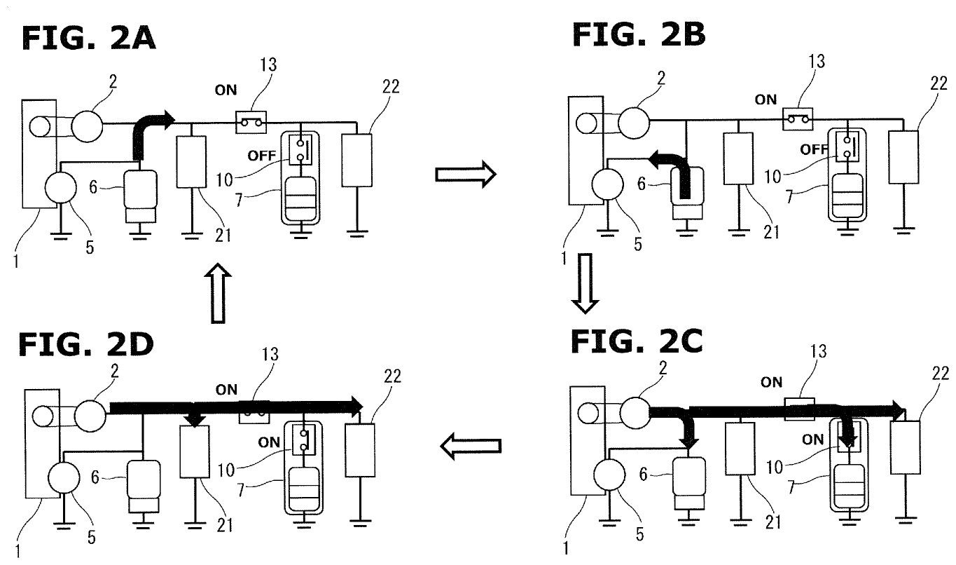

FIGS. 2A to 2D are explanatory drawings showing basic operations of the power supply system of the embodiment shown in FIG. 1. In the following explanatory drawings including FIGS. 2A to 2D, a main current flow is indicated by an arrow. FIG. 2A illustrates a state in which an ignition switch of the vehicle is OFF. In this ignition switch OFF state, the circuit interrupting switch 13 is ON (conduction state), and the LiB relay 10 is controlled to be OFF (interruption state or cut-off state). Although a number of electric loads do not require power in this ignition switch OFF state, some electric loads consume power even during standby, and a so-called standby current flows in the circuit. As indicated by the arrow in FIG. 2A, power required for both of the load A group 21 and the load B group 22 during standby is supplied by the lead-acid battery 6. Since the LiB relay 10 is in the cut-off state, the charge amount of the lithium-ion battery 7 does not decrease.

When the ignition switch is turned ON, as indicated by the arrow in FIG. 2B, power is supplied to the starter motor 5 from the lead-acid battery 6, and cranking and start (initial start) of the engine 1 are carried out. During the cranking, the LiB relay 10 is held OFF, and the lithium-ion battery 7 does not consume power.

When completing the engine start, as illustrated in FIG. 2C, the LiB relay 10 is turned ON. Therefore, as indicated by the arrows, by power generation of the alternator 2, both of the lead-acid battery 6 and the lithium-ion battery 7 are charged. Each voltage is controlled so that the charge amount of the lead-acid battery 6, which has been decreased due to its power consumption during the ignition switch OFF and during the cranking, and the charge amount of the lithium-ion battery 7, which has been slightly lowered due to natural discharge (self-discharge), are quickly recovered.

FIG. 2D illustrates a normal travel state in which the lead-acid battery 6 and the lithium-ion battery 7 are sufficiently charged. The circuit interrupting switch 13 and the LiB relay 10 are each in an ON state. In this state, the load A group 21 and the load B group 22 are basically supplied with power from the alternator 2. If the charge amount of the lithium-ion battery 7 is sufficiently charged, the use of the automatic driving function is permitted. Further, if the charge amount of the lead-acid battery 6 is sufficiently charged, an idling stop control for stopping operation of the engine 1 at a time of vehicle stop at an intersection etc. is permitted.

When the vehicle stops and the ignition switch is turned OFF from the control state of FIG. 2D, the LiB relay 10 is turned OFF, and the state is returned to FIG. 2A again.

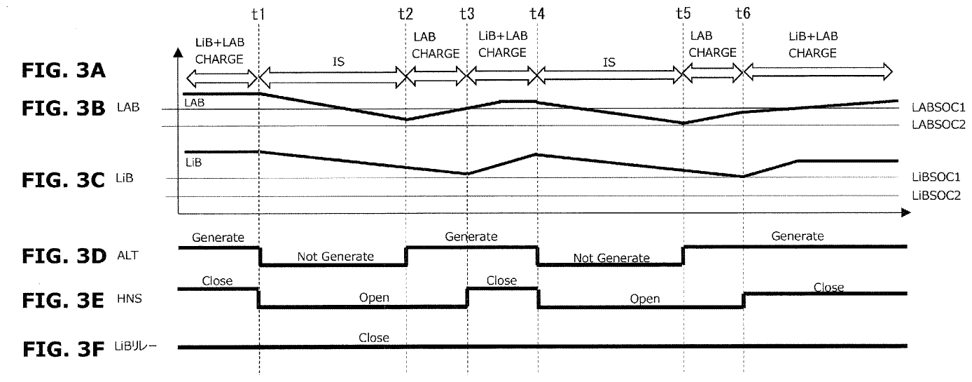

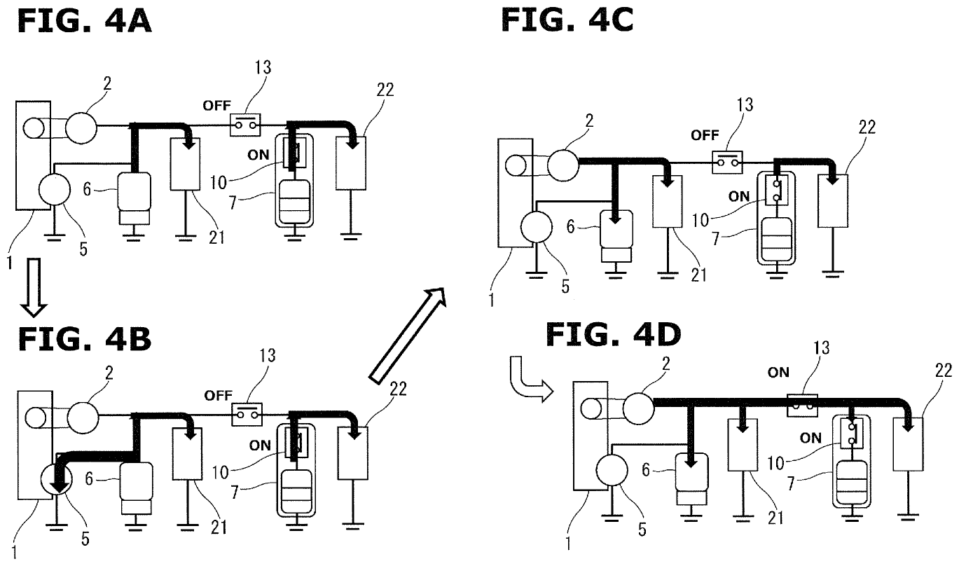

Next, the power supply control when performing the idling stop control, which is an essential part of the present invention, will be described with reference to time charts of FIGS. 3A to 3F and operation explanatory drawings of FIGS. 4A to 4D.

The idling stop control is an effective means in terms of reduction in fuel consumption of the vehicle. The idling stop control is executed when several idling stop conditions, such as a vehicle speed being substantially zero, after warming-up (i.e. warming-up being completed), an accelerator pedal OFF, a brake pedal ON, the charge amount of the lead-acid battery 6 and the charge amount of the lithium-ion battery 7 being predetermined levels (after-mentioned LABSOC2, LiBSOC1) or more, etc., are simultaneously satisfied (so-called AND conditions), and the engine 1 is automatically stopped. After that, when any one of several restart conditions, such as a brake pedal OFF, a start request from the air conditioner, etc., is satisfied (so-called OR condition), automatic restart is executed.

FIGS. 4A to 4D are explanatory drawings showing operations when performing the idling stop control. When the idling stop conditions are satisfied and the idling stop control is started from the normal control state of FIG. 2D, as illustrated in FIG. 4A, the circuit interrupting switch 13 is turned OFF, whereas the LiB relay 10 remains in the ON state. Because the engine 1 stops and the power generation of the alternator 2 stops while the idling stop control is executed, the load A group 21 is supplied with power from the lead-acid battery 6, and the load B group 22 is supplied with power from the lithium-ion battery 7. With this, the two automatic driving electric loads, which are included in the load A group 21 and the load B group 22 respectively and form the redundant system, are surely supplied with power.

Here, as one of the idling stop conditions, it is preferable to include a condition that the LiB relay 10 is actually in the ON state in the idling stop conditions. That is, it is desirable to prevent the idling stop control from being started in a state in which power supply to the load B group 22 from the lithium-ion battery 7 is not possible.

Next, when the restart condition is satisfied and the restart is performed, as illustrated in FIG. 4B, power is supplied to the starter motor 5 from the lead-acid battery 6, and the cranking for the restart is executed. At this time, the circuit interrupting switch 13 is held OFF, and the LiB relay 10 is held ON. Therefore, while power supply from the lithium-ion battery 7 to the automatic driving electric load of the load B group 22 is continued, the lithium-ion battery 7 is separated (disconnected) from the starter motor 5 and the lead-acid battery 6, then no power is drawn from the lithium-ion battery 7 to the main circuit 11 side. In particular, since the internal resistance of the lithium-ion battery 7 is small as compared with that of the lead-acid battery 6, if both of the lead-acid battery 6 and the lithium-ion battery 7 are connected to the starter motor 5, power on the lithium-ion battery 7 side is preferentially consumed. Since the circuit interrupting switch 13 is OFF, the lithium-ion battery 7 is not affected when performing the restart.

Here, in the above embodiment, in preparation for the restart, the circuit interrupting switch 13 is controlled to be OFF substantially simultaneously with the start of the idling stop control. Therefore, a delay time for turning the circuit interrupting switch 13 OFF when a restart request arises does not occur, and the restart can be executed quickly. In addition, there is no concern of drawing of power from the lithium-ion battery 7 to the load A group 21 during the idling stop control.

It is noted that in the present invention, the circuit interrupting switch 13 may be controlled to be OFF with a delay after the start of the idling stop control, but the circuit interrupting switch 13 must be in the interruption state at least at the time of the cranking of the restart.

FIG. 4C indicates a control state immediately after the restart. After the restart, first, charge of the lead-acid battery 6 is preferentially carried out. Therefore, a state in which the circuit interrupting switch 13 is OFF continues for a predetermined time period after the restart. By power generation of the alternator 2, the lead-acid battery 6 is charged. For this time period, the load B group 22 is supplied with power from the lithium-ion battery 7. In this manner, by preferentially charging the lead-acid battery 6 with the circuit interrupting switch 13 being OFF, the charge state of the lead-acid battery 6, whose charge amount is relatively considerably lowered due to the cranking when performing the restart, is quickly recovered. If not only the lead-acid battery 6 but also the lithium-ion battery 7 are connected to the alternator 2, since the lithium-ion battery 7 is also charged in parallel with the charge of the lead-acid battery 6, the charge of the lead-acid battery 6 is slow. In particular, in the case of the embodiment in which the lithium-ion battery 7 is combined, since the internal resistance of the lead-acid battery 6 is greater than that of the lithium-ion battery 7, the charge of the lithium-ion battery 7 proceeds relatively easily, and the charge of the lead-acid battery 6 tends to be delayed. In the above embodiment, by performing the preferential charge of the lead-acid battery 6 immediately after the restart with the circuit interrupting switch 13 being OFF, even if the idling stop control is frequently repeated, the charge state of the lead-acid battery 6 can be maintained at a level capable of performing the restart.

After the preferential charge of the lead-acid battery 6, as illustrated in FIG. 4D, the circuit interrupting switch 13 is controlled to be ON, and both of the lead-acid battery 6 and the lithium-ion battery 7 are charged.

FIGS. 3A to 3F are time charts showing the power supply control when performing the idling stop control. In this example, the idling stop control is executed twice. In an uppermost FIG. 3A, a period denoted by “IS” is a period of the idling stop control (corresponding to FIG. 4A), a period denoted by “LAB CHARGE” is a preferential charge period of the lead-acid battery 6 (corresponding to FIG. 4C), and a period denoted by “LiB+LAB CHARGE” is a charge period of the both lithium-ion battery 7 and lead-acid battery 6 (corresponding to FIG. 4D). As described above, after the idling stop control is ended, the predetermined time period becomes the preferential charge period of the lead-acid battery 6, and subsequently, the control is shifted to the charge of the both lithium-ion battery 7 and lead-acid battery 6.

FIG. 3B indicates change in the charge amount (SOC) of the lead-acid battery 6 (in the drawing, this is abbreviated as “LAB”). LABSOC 1 is a target SOC (corresponding to a first predetermined value in claims) of the lead-acid battery 6 for ending the preferential charge of the lead-acid battery 6 after the restart. LABSOC 2 is an idling stop prohibition SOC of the lead-acid battery 6 which is one of the idling stop conditions. The LABSOC 2 is set to a value that is lower than the LABSOC 1. When the charge amount (SOC) of the lead-acid battery 6 falls below the LABSOC 2, the idling stop control is prohibited, and after that, a state in which the idling stop control is prohibited continues as a so-called hysteresis until the charge amount (SOC) of the lead-acid battery 6 is returned (recovered) to the LABSOC 1. The charge amount of the lead-acid battery 6 decreases due to the power consumption of the load A group 21 during the idling stop control and due to the cranking when performing the restart, and subsequently increases in the charge period. In the example shown in the drawing, the preferential charge period of the lead-acid battery 6 after the first idling stop control is ended by the fact that the charge amount of the lead-acid battery 6 reaches the LABSOC 1 at time t3. That is, the predetermined time period for which the preferential charge of the lead-acid battery 6 is performed is considered to elapse by the fact that the charge amount (SOC) of the lead-acid battery 6 reaches the charge target LABSOC 1.

Here, the first idling stop control is ended by, for instance, the brake pedal OFF by a driver at time t2. A second idling stop control is ended by the fact that the charge amount of the lead-acid battery 6 is lowered to the LABSOC 2 at time t5.

FIG. 3C indicates change in the charge amount (SOC) of the lithium-ion battery 7 (in the drawing, this is abbreviated as “LiB”). LiBSOC 1 is an idling stop prohibition SOC for prohibiting the idling stop control when the charge amount (SOC) of the lithium-ion battery 7 is the LiBSOC 1 or less.

This LiBSOC 1 is also a lower limit soc (corresponding to a second predetermined value in claims) indicating that the lithium-ion battery 7 should be charged, and when the charge amount of the lithium-ion battery 7 is lowered to the LiBSOC 1 while the preferential charge of the lead-acid battery 6 is performed after the idling stop control, the control is shifted to the charge of the both lithium-ion battery 7 and lead-acid battery 6. LiBSOC 2 is an automatic driving warning SOC that is a lower limit capable of outputting power necessary for the automatic driving function to the automatic driving electric load of the load B group 22. When the charge amount of the lithium-ion battery 7 falls below this LiBSOC 2 during execution of the automatic driving, an alert (voice, screen display, etc.) that alerts the driver to change the automatic driving to a manual driving is issued. The LiBSOC 1 is set to a value that is higher than the LiBSOC 2 so that an appropriate margin before the issuance of the alert is given. The charge amount of the lithium-ion battery 7 decreases due to the power consumption of the load B group 22 during the idling stop control and in the subsequent preferential charge period of the lead-acid battery 6, and increases in the charge period of the both lithium-ion battery 7 and lead-acid battery 6. In the example shown in the drawing, the preferential charge period of the lead-acid battery 6 after the second idling stop control is ended by the fact that the charge amount of the lithium-ion battery 7 is lowered to the LiBSOC 1 at time t6. That is, a predetermined time period for which the preferential charge of the lead-acid battery 6 is performed is considered to elapse by the fact that the charge amount (SOC) of the lithium-ion battery 7 is lowered to the LiBSOC 1.

It is noted that the predetermined time period for which the preferential charge of the lead-acid battery 6 is performed may be determined by its duration time. In this case, the preferential charge of the lead-acid battery 6 is ended when a certain time has elapsed, then the control is shifted to the charge of the both lithium-ion battery 7 and lead-acid battery 6. In particular, in order to avoid a situation in which both of the lithium-ion battery 7 and lead-acid battery 6 are not charged due to some abnormality, it is desirable to set an appropriate upper limit time for the preferential charge of the lead-acid battery 6.

FIG. 3D indicates whether the alternator 2 is in a power generating state (Generate) or a non-power generating state (Not Generate) (in the drawing, this is abbreviated as “ALT”). The power generation stops during the idling stop control.

FIG. 3E indicates an open/closed state of the circuit interrupting switch 13 (in the drawing, this is abbreviated as “HNS”). The circuit interrupting switch 13 is open (OFF) during the idling stop control and in the preferential charge period of the lead-acid battery 6, and is closed (ON) in the charge period of the both lithium-ion battery 7 and lead-acid battery 6. FIG. 3F indicates an open/close state of the LiB relay 10. The LiB relay 10 is held in a closed state (ON) in a period of the time chart of the drawing.

As described above, in the above embodiment, regarding the predetermined time period for which the preferential charge of the lead-acid battery 6 is performed, when any one of conditions that the charge amount of the lead-acid battery 6 reaches the LABSOC 1, that the charge amount of the lithium-ion battery 7 is lowered to the LiBSOC 1 and that the duration time of the preferential charge of the lead-acid battery 6 reaches the predetermined upper limit time is satisfied, the predetermined time period is considered to elapse. The present invention could use not only OR condition of these three, but also use one appropriate condition or combination of a plurality of conditions.

Although the invention has been described above by reference to the embodiment of the invention, the invention is not limited to the embodiment described above, and various modifications can be made. For instance, in the above embodiment, the lead-acid battery 6 is used as the first power storage device, and the lithium-ion battery 7 is used as the second power storage device. However, as the power storage device, any type of devices such as proper secondary battery and capacitor could be used.

Further, the above embodiment is described with the alternator 2 being the mere generator and the starter motor 5 being the motor that performs the cranking. However, the cranking at the time of the engine start could be performed using a motor/generator having the function as a generator. Alternatively, the motor/generator having the function as the generator and the starter motor are provided, the initial start could be executed by the starter motor, and the restart after the idling stop control could be executed by the motor/generator.

In addition, in the above embodiment, the automatic driving electric load is divided into the two electric loads as the redundant system. However, the present invention is not limited to this redundant system, but can be applied to other redundant system.

1-8. (canceled)

9. A method of controlling a vehicle having an engine, a generator driven by the engine and generating power, a first power storage device and a second power storage device each charged by power generated by the generator and each supplying power necessary for automatic driving of the vehicle to an automatic driving electric load, and a disconnecting device provided between the first power storage device and the second power storage device, the method comprising:
when predetermined conditions are satisfied at a time of vehicle stop, executing an idling stop control for stopping the engine;
performing cranking of the engine by power of the first power storage device with the disconnecting device being in an interruption state when ending the idling stop control and restarting the engine;
charging the first power storage device without charging the second power storage device with the disconnecting device being held in the interruption state for a predetermined time period after the restart; and
charging both of the first power storage device and the second power storage device with the disconnecting device being in a conduction state after the predetermined time period elapses,
wherein the predetermined time period is considered to elapse when a charge state of the second power storage device lowers to a second predetermined value, wherein the second predetermined value is set to a value that is higher than an automatic driving warning SOC at which an alert that alerts to change the automatic driving to a manual driving is issued.

10. The method of controlling the vehicle as claimed in claim 9, further comprising:
bringing the disconnecting device into the interruption state substantially simultaneously with a start of the idling stop control.

11. The method of controlling the vehicle as claimed in claim 9, wherein
the predetermined time period is considered to elapse when a charge state of the first power storage device reaches a first predetermined value.

12. The method of controlling the vehicle as claimed in claim 9, wherein
the automatic driving electric load includes a first electric load and a second electric load, and
the method further comprising:
when the disconnecting device is in the interruption state, supplying power to the first electric load from the first power storage device, and supplying power to the second electric load from the second power storage device.

13. The method of controlling the vehicle as claimed in claim 9, wherein
the vehicle further has a second disconnecting device provided between the second electric load and the second power storage device, and
the method further comprising:
as one of the predetermined conditions, including a condition that the second disconnecting device is in a conduction state.

14. A control device of a vehicle comprising:
an engine;
a generator driven by the engine and generating power;
a first power storage device and a second power storage device each charged by power generated by the generator and each supplying power necessary for automatic driving of the vehicle to an automatic driving electric load;
a disconnecting device provided between the first power storage device and the second power storage device; and
a controller configured to, when predetermined conditions are satisfied at a time of vehicle stop, execute an idling stop control for stopping the engine, perform cranking of the engine by power of the first power storage device with the disconnecting device being in an interruption state when ending the idling stop control and restarting the engine, and charge the first power storage device without charging the second power storage device with the disconnecting device being held in the interruption state for a predetermined time period after the restart, and further configured to charge both of the first power storage device and the second power storage device with the disconnecting device being in a conduction state after the predetermined time period elapses,
wherein the predetermined time period is considered to elapse when a charge state of the second power storage device lowers to a second predetermined value, wherein the second predetermined value is set to a value that is higher than an automatic driving warning SOC at which an alert that alerts to change the automatic driving to a manual driving is issued.
